(19) United States
(12) Patent Application Publication
(10) Pub. No.: US 2005/0015752 A1
(43) Pub. Date: Jan. 20, 2005

(54) Static analysis based error reduction for software applications

(75) Inventors: Bowen Alpern, Peekskill, NY (US); Robert D. Johnson, Ridgefield, CT (US); Aaron S. Kershenbaum, New City, NY (US); Lawrence Koved, Pleasantville, NY (US); George B. Leeman JR., Ridgefield, CT (US); Marco Pistoia, Yorktown Heights, NY (US); Darrell C. Reimer, White Plains, NY (US); Kavitha Srinivas, Rye, NY (US); Harini Srinivasan, Tarrytown, NY (US)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, ARMONK, NY (US)

(21) Appl. No.: 10/620,078

(22) Filed: Jul. 15, 2003

(51) Int. Cl. G06F 9/44; G06F 9/45

(52) U.S. Cl. 717/131; 717/141; 717/155; 717/156

(57) ABSTRACT

A system and method for providing “static analysis” of programs to aid in improving runtime performance, stability, security and privacy characteristics of deployed application code. The method includes performing a set of analyses that sifts through the program code and identifies programming security and/or privacy model coding errors. In particular the invention focuses on identifying coding errors that cause loss of correctness, performance degradation, security, privacy and maintainability vulnerabilities. A deep analysis of the program is performed using detailed control and data flow analyses. These deeper analyses provide a much better perspective of the overall application behavior. This deep analysis is in contrast to shallow analyses in current industry tools, which inspect or model a single or a few classes at a time.

### BACKGROUND OF THE INVENTION

1. Field of the Invention

The present invention relates generally to debug and analysis of software, and more particularly, to a novel application that provides automated static analysis techniques for analyzing programs using detailed control and data flow analyses.

2. Description of the Prior Art

The industry standard Java 2 Enterprise Edition (J2EE)™ platform provides a rich and flexible environment for developing a wide range of server applications. Developers have the freedom to choose from a multitude of options both in the components they use, and in how they use each component to write their applications. However, the model has a number of pitfalls that can cause performance, correctness, security, privacy and/or maintainability problems for deployed applications. The challenge is in identifying misuses of the Java and J2EE programming models.

More particularly, the J2EE platform defines a standard for building scalable componentized enterprise applications. FIG. 1 illustrates the J2EE development platform 100 for building scalable componentized enterprise applications. Such applications in the form of servlets 110, JavaServer Pages (JSP) 115, Enterprise JavaBeans 120, etc. reside in a mid-tier server 150 to provide and support mid-tier service functionality, e.g., execute middleware transactions such as Java DataBase Connectivity 160 (JDBC) or Java Message Service (JMS) for remote clients 99. The J2EE platform provides many of the functions commonly needed by distributed transactional applications, thereby reducing and simplifying the code application developers must write. Like most other programming frameworks, applications developed using the J2EE frameworks usually are accompanied with both correctness and performance problems. Even though the J2EE framework simplifies application code, the resulting systems being constructed are very complex and scale to very large workloads.

As with any large distributed transactional system, errors are usually difficult to diagnose both due to the possible subtlety of the error and due to the immense amount of code that makes up the application and infrastructure. J2EE may reduce the amount of application code that has to be written to get certain business functionality, but it does not mean J2EE applications are small. In addition to application errors, performance and scalability of J2EE applications can vary widely. Application architects and developers are free to choose from the large number of building blocks of the J2EE framework in a variety of ways. However, it is the case that these frameworks are so rich that most developers do not have the opportunity and/or capacity to absorb the details of the platform in its entirety. This richness, combined with the rapid rate at which new functionality is being added to these frameworks, results in a development community problem. Very few users are able understand all the facets of J2EE. For example, J2EE 1.1 consists of 13 standard extensions in addition to all of J2EE (Java 2 Standard Edition). Looking at the implementations from J2EE application server providers, it is noticed that there could easily be over 20,000 classes included in a J2EE runtime. This includes the J2SE runtime components, the J2EE specification components and the J2EE provider components. Typically an application consisting of 100s to 1000s of classes are added on top of this infrastructure. The resulting system is deployed into a distributed environment, which is itself complex.

Furthermore, debugging and performance tuning is very challenging since it often requires a global perspective. Without proper experience and testing, the resulting applications can perform poorly and do not scale.

In the face of such complexity, one way to architect and develop high performance scalable applications is to follow “Best Practices” of usage of the components that comprise the J2EE framework. These “Best Practices” of usage comprise programming techniques that have been compiled by experts for each component of J2EE and provide a way for J2EE architects and developers to avoid the common pitfalls made by their colleagues. The problem with this approach is that the dissemination of Best Practices is usually ad hoc. Many architects and developers often end up repeating the mistakes of their colleagues.

Thus, there exists a need for a tool that formalizes a set of Best Practices applicable to the J2EE platform and automates the detection of violations of these Best Practices.

While it is difficult to determine whether an application adheres to “Best Practices”, it is often simpler to determine where an application violates known “Best Practices” or contains known common design or coding errors. However, developing individual rules and analyses to identify each error condition is a daunting task.

Thus, it would be highly desirable to provide a tool that formalizes a set of Best Practices applicable to the J2EE platform or like program framework, and that groups violations of them.

### SUMMARY OF THE INVENTION

It is an object of the present invention to provide a very general framework for analyzing and identifying program errors that occur when developing software code.

It is a further object of the present invention to provide a very general framework for analyzing and identifying program errors that occur when developing Java code implemented for applications such as J2EE and J2SE.

In attainment of these objective there is provided a tool that formalizes a set of Best Practices applicable to the J2EE platform and automates the detection of violations of these Best Practices. The tool, in addition to formalizing sets of Best Practices applicable to the J2EE platform, facilitates the development of individual rules and analyses for new Best Practices applicable to the J2EE platform. It permits the easy extension of the set of rules to new Best Practices as they are discovered.

In a preferred embodiment, the tool groups violations of the “Best Practices” applicable to the J2EE platform according to categories based on the types of analyses performed. In addition, the technique for applying the new set of rules to any given application is greatly simplified. Such a categorization permits the easy extension of the set of rules to new Best Practices as they are discovered and simplifies the application of the new set of rules to any given application.

The tool of the invention, providing static analysis-based error reduction (SABER), preferably comprises a system and software architecture for identifying and analyzing problems, and helping to provide solutions for problems encountered in J2EE applications including problems that fall under two major groups—J2EE programming pitfalls and the more general Java programming pitfalls, both of which are relevant in the context of J2EE applications. The system and software architecture categorizes the common problems based on the analysis needed to identify them via a static analysis of the J2EE applications. The static analysis techniques are automated techniques and the present tool identifies the common problems associated with J2EE applications before they are deployed (e.g., during development or quality assurance review) in order to identify most performance, correctness, security, privacy and maintainability problems prior to deployment.

Thus, according to the principles of the invention, there is provided a system and method for analyzing software code comprising the steps of: automatically generating control and data flow analysis graphs representing said code utilizing static analysis techniques; automatically applying a set of rules to said control and data flow analysis graphs, a rules set representing use of best practices; automatically identifying potential best practices violations indicative of software performance, correctness, security, privacy and/or maintainability problems from rules set analysis results; and, reporting said violations to enable correction of instances where errors may occur according to said best practices violations.

Advantageously, the same techniques implemented in the present invention can be applied to other programming development frameworks including, but not limited to, Java 2 Micro Edition (J2ME), Object Management Group's Common Object Request Broker Architecture (CORBA), or Microsoft C#/CLR and .NET frameworks.

### BRIEF DESCRIPTION OF THE FIGURES

The objects, features and advantages of the present invention will become apparent to one skilled in the art, in view of the following detailed description taken in combination with the attached drawings, in which:

FIG. 1 illustrates the J2EE development platform for building scalable componentized enterprise applications;

FIG. 2 is a diagram depicting a software architecture and methodology of the SABER tool of the invention employed by the development platform of FIG. 1;

FIG. 3 is a more detailed flow diagram depicting the methodology employed in FIG. 2 by the development platform of FIG. 1 including code analysis, report generation and display;

FIG. 4 is a detailed flow chart depicting the system and method for performing the application code analysis including the generation of control and data flow graphs according to step 330 of FIG. 3.

FIG. 5 is a detailed analysis of the graph rewriting sub-system and methodology employed by the tool of the present invention;

FIG. 6 is a detailed analysis of the graph reachability sub-system and methodology employed by the tool of the present invention;

FIG. 7 is a detailed diagram outlining two rules that may be implemented by the SABER tool of the invention;

FIG. 8 outlines a SABER rule that identifies a set of methods that are being called when a monitor is held by the thread of execution.

FIG. 9 outlines a SABER rule that identifies modification of the value or state of shared fields for any threads executing in a particular component; and,

FIG. 10 outlines a SABER rule that describes the types or attributes of objects that can be stored in specific fields.

### DETAILED DESCRIPTION OF THE PREFERRED EMBODIMENTS

The present invention, providing static analysis-based error reduction (SABER), is a tool that formalizes a set of Best Practices applicable to the J2EE platform and automates the detection of violations of these Best Practices.

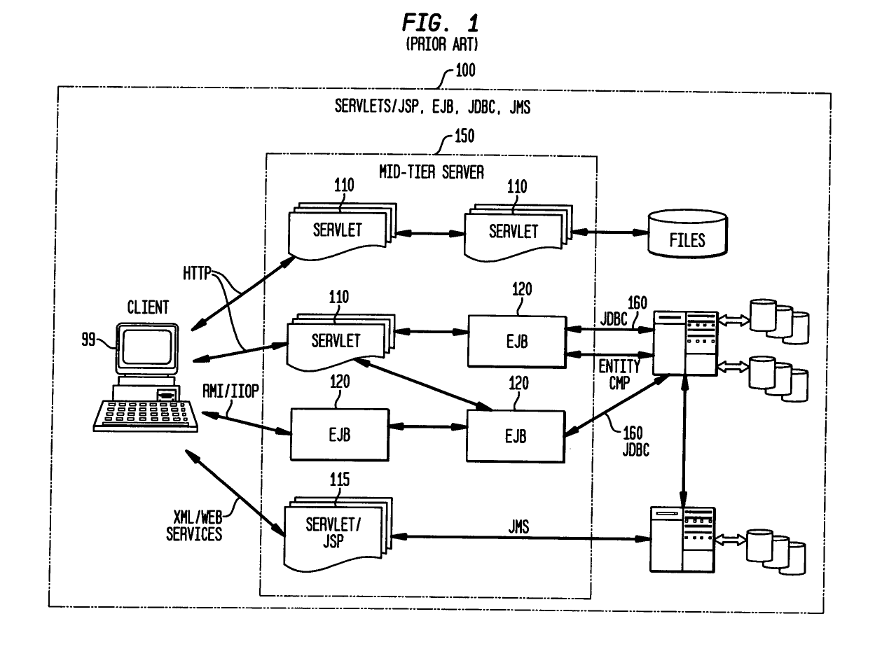

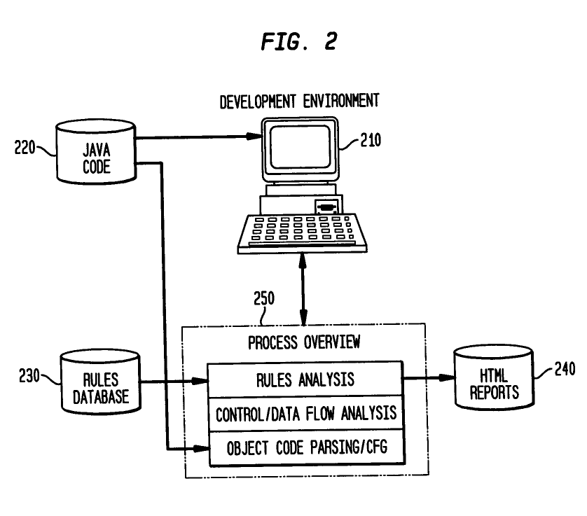

FIG. 2 is a diagram depicting a software architecture and methodology of the SABER tool of the invention employed for the development platform of FIG. 1 and particularly an example usage scenario.

In the embodiment depicted in FIG. 2, a developer writes code, e.g., Java code, in a development environment 210 including a P.C. or workstation. The resulting code, as well as any libraries or middleware that would be part of a deployed application, is written to a repository 220, which may comprise a file system, web server, or other data storage device. A description of what to analyze and how the deployment is configured is provided to an analysis framework 250, along with a set of analysis rules stored in a rules database 230. The analysis rules are applied to the code, as well as any libraries or middleware of the deployed application, and the results of the analysis are made available through any number of means, including HTML reports 240 or through the development environment 210.

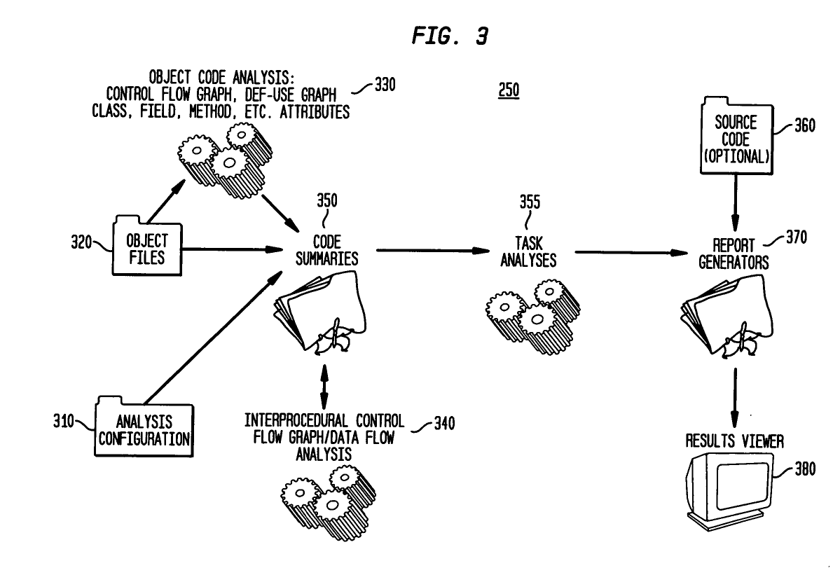

FIG. 3 is a more detailed flow diagram depicting the methodology employed by the development platform of FIG. 1 including an example analysis scenario. FIG. 3 particularly depicts the processes performed in the analysis framework step 250 of FIG. 2, whereby the developed code, e.g., object code, source code or other program representation such as an intermediate representation as produced by a compiler is analyzed and reports are generated and displayed. A description of the analysis, including deployment and configuration information 310 is used to configure the analysis frameworks. The object code, source code or other program representation 320 is located in the repository 220 and made available for reading as is necessary by employment of class/code analysis techniques 330 including, but not limited to: Class hierarchy analysis, Rapid Type Analysis, control flow graphs, data flow graphs, and the like. The class/code analysis 330 reads the code, produces an intraprocedural Control Flow Graph (CFG), data flow graph (Def-Use graph), and further identifies classes, fields, methods and other attributes of a class. The class/code analysis can be performed when the framework is initialized, or can be performed incrementally as needed by analyses, including the interprocedural analysis 340. The result of class/code analysis 330 and interprocedural analysis 340 is a summary of the classes/code, control and data flows 350. These summaries 350, including graphs of control and data flows, are used by analyses 355 and their rules 230 (FIG. 2) to generate reports 370 that describe coding and/or performance and/or security and/or privacy and/or maintainability errors identified in the code. The results of the analyses 355 are then optionally combined with the source code 360 and presented to the programmer or other user 380 by an appropriate viewer.

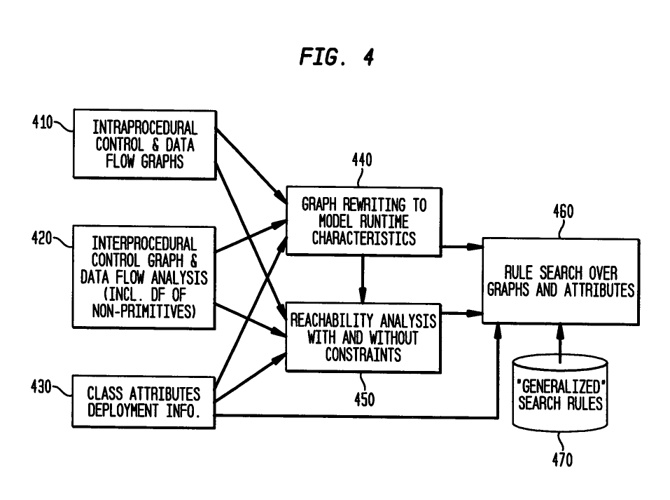

FIG. 4 is a detailed flow chart depicting the system and method for performing the application code analysis including the generation of control and data flow graphs according to step 330 of FIG. 3. In the preferred embodiment, both intraprocedural control and data flow graphs and interprocedural control and data flow graphs are implemented in the analyses.

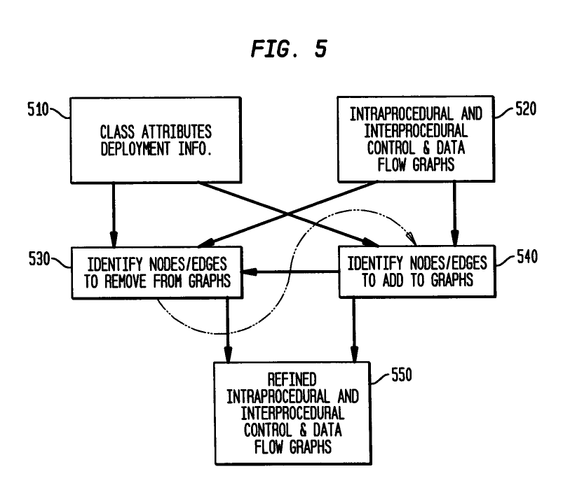

As shown in FIG. 4, there is depicted the steps of providing the intraprocedural control and data flow graphs 410 and interprocedural control and data flow graphs 420 which may include-the analyses of non-primitive types (e.g., classes). Class attribute information 430 is also extracted from the classes as depicted in FIG. 4. All of these graphs, class attribute and additional program deployment (configuration) information are input to a graph rewriting application to model runtime characteristics, as depicted at step 440 and described in greater detail in FIG. 5. The same inputs in addition to the results of the graph rewriting application of the previous step are supplied to a reachability analysis application at step 450. It is understood that the reachability analysis may be performed with and without the use of constraints. For example, a number of the analyses require that it is known whether a specific or collection of methods is called starting from some entry point into an application or component. To reduce “false positive” reports, the search may further be constrained to ignore nodes in the graph that pass through a specified set of nodes (e.g., method invocations). The results of the graph rewriting 440, reachability analyses 450 and the class attribute and configuration deployment information are input to a rule search engine 460 that traverses the graphs and attributes to identify possible coding and/or performance and/or security and/or privacy defects. The rule search engine traverses the graphs and applies the “generalized” search rules 470 useful for identifying potential “Best Practices” violations and performance errors. The categories of rules 470 useful for identifying potential “Best Practices” violations and performance errors applied in the SABER tool include, but are not limited to:
Never call X
Never call X from Y
Never call X from within synchronized code
Data race Detection
Deadlock detection (Java and Database)
Never call X more than Y times
If you call X, you must call Y
After you call X, you must always call Y
If you modify X, you must call Y
If you did not modify X, do not call Y
Servlet/EJB methods must not have X attrib.
Never extend/implement X
Never store values in Servlet fields or EJB static fields
Store objects of type X in Y fields
Objects stored in Y fields must have specific attributes (e.g., Serializable)
EJB parameters must not contain EJB instance reference
J2SE coding rules
‘transient’ field rules
Correct implementation of equals(), compareTo() and hashCode()
Empty exception handlers
Overloaded exception handlers

FIG. 5 is a detailed analysis of the graph rewriting sub-system and methodology employed by the SABER tool of the present invention.

Class attributes and deployment information (430, FIG. 4) are used as input to the system as depicted at step 510. Intraprocedural and interprocedural control and data flow graphs (410, 420, FIG. 4) are additional inputs to the graph rewriting sub-system as depicted at step 520. An example of identifying and adding an edge in graph rewriting is depicted at step 540. For example, an edge can be added to represent an invocation from a Thread.start() method to a Thread.run() method, i.e., a depiction that the result of a call to Thread.start() results in the invocation of a Thread.run() method. Similarly, when determining which interprocedural nodes are in a thread of execution, edges from Thread.start() to Thread.run() are removed, such as depicted at step 530. Another example is the addition of edges from within an intraprocedural analysis to the class constructor based on Java's “first active use” rule that specifies when a class constructor must execute. Similar sorts of transformations may additionally be applied to the data flow graphs. The result is the refined control and data flow graphs 550 used by the analyses at step 460 (FIG. 4).

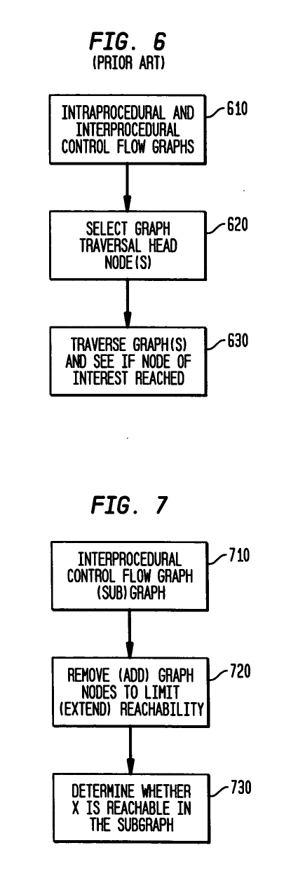

FIG. 6 is a detailed analysis of the graph reachability sub-system and methodology employed by the tool of the present invention. According to the invention, graph reachability is based on well know graph algorithms, particularly those for directed graphs. From a “head node” provided in an intraprocedural or interprocedural analysis 610, traversal of the graph 620 may be started to locate a node containing properties of interest 630 (a specific method, a load or store to a field with specific attributes, etc.).

FIG. 7 is a detailed diagram outlining two rules that may be implemented by the SABER tool of the invention as depicted in the methodology shown in FIGS. 1-6. The rules depicted in FIG. 7 include: “Never Call X” and “Never Call X from Y” although other rules may be implemented as described herein.

Specifically, given the inter procedural control flow graph (or one of its subgraphs) 710, a graph traversal as depicted at step 720 is performed to add or remove edges respectively to extend or reduce reachability in the manner as described herein. In one example depicted, the reachability traversal of the graph 730 is implemented to search for a node attribute which is the method whose signature is X. When X is found, a report is generated. The difference between the two rules, “Never Call X” and “Never Call X from Y” is the selection of the head node(s) from where the graph traversal is initiated.

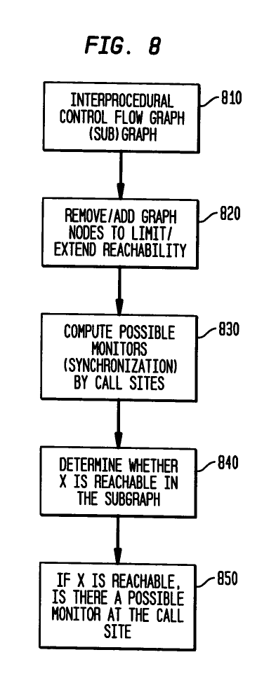

FIG. 8 outlines a SABER rule that checks whether a set of methods are being called when a monitor may be held by the thread of execution. This rule may be referred to as “Never Call X When Synchronized”. Given the inter procedural control flow graph (or one of its subgraphs) 810, a graph traversal is first performed at step 820 to add or remove edges to respectively extend or reduce reachability. Synchronization is then computed at those call sites where synchronization (i.e., monitors possibly held by the thread) may occur as indicated at step 830. Using the inter procedural control flow graph, it is determined whether method X is called, i.e., is reachable in the traversed graph, at step 840. If X is reachable, it is determined at step 850 whether the thread at the call site may hold a monitor 850. If a monitor is held at the call site, a report is generated indicating synchronization.

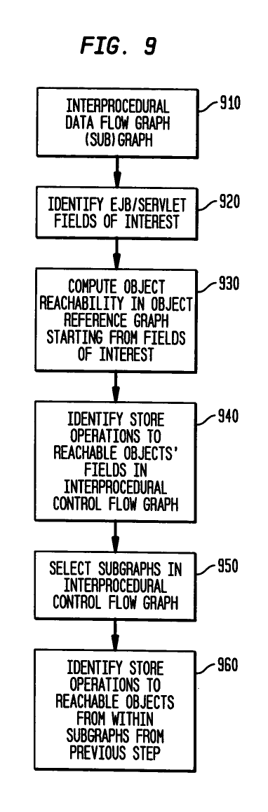

FIG. 9 outlines the rule that any threads executing that component should not modify the value or state of shared fields. For example, this rule may be referred to as “Never Store Values in Servlet Fields or EJB Static Fields”.

The methodology depicted in FIG. 9 includes a first step 910 of computing the Inter procedural data flow graph and selecting the (EJB/Servlet) fields of interest for analysis at step 920. The set of objects reachable from the selected fields is computed at step 930 and store operations to the fields and objects reachable from the objects stored in the fields are identified at step 940. Selected subgraphs of the inter procedural control flow graph 950 are identified as being places where store operations are not allowed (e.g., non-constructors such as the Servlet.service() and HttpServlet.doGet() methods). Then, there is performed the step of identifying whether the store operations identified at step 940 occur in the subgraphs identified, and if so, generating a report.

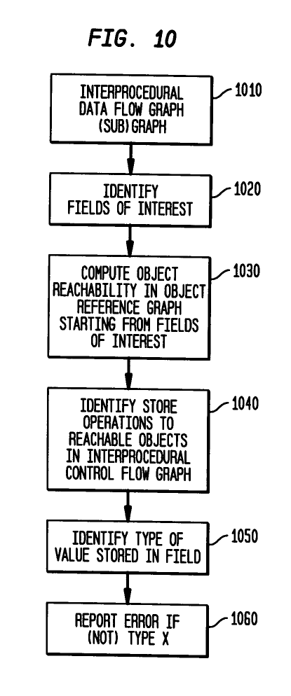

FIG. 10 outlines the rules describing the types or attributes of objects that can not (can) be stored in specific fields. For example, this rule may be referred to as “Never (Always) Store Objects of Type X in Y Fields”.

The methodology depicted in FIG. 10 includes a first step 1010 of computing the Inter procedural data flow graph and selecting the fields of interest for analysis at step 1020. The set of objects reachable from the selected fields is computed at step 1030 and store operations to the fields and objects reachable from the objects stored in the fields is computed at step 1040. The type(s) of the objects reachable from the fields is determined at step 1050. If the type or attribute of the reachable objects is unacceptable (e.g., non-Serializable) as indicated at step 1060, then a report is generated.

While the SABER tool of the invention formalizes sets of Best Practices applicable to the J2EE platform, it additionally facilitates the development of individual rules and analyses for new Best Practices applicable to the J2EE platform. It permits the easy extension of the set of rules to new Best Practices as they are discovered. While the tool detects violations of J2EE, J2SE programming rules and other best practices, it does not directly suggest a way to fix these problems. However, the identification of these violations provides the skilled artisan with the knowledge for modifying or re-writing the code to avoid the detected violations. An advanced embodiment of the present invention could automate the correction of some of the violations of Best Practices by using techniques (e.g., program slicing) that are known to those skilled in the art.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

1. A method for analyzing software code comprising the steps of:
a) automatically generating program graphs representing said code utilizing static analysis techniques;
b) automatically applying a set of rules to said program flow analysis graphs;
c) automatically identifying potential software problems from rules set analysis results; and,
d) reporting said software problems where one or more of best practices violations and coding errors may occur control and data flow analysis.

2. The method according to claim 1, wherein said rules set represents one or more selected from the group comprising: use of best practices and common coding errors, or combinations thereof.

3. The method according to claim 1, wherein said reporting d) includes presenting the results in the context of corresponding source code or object code.

4. The method according to claim 1, wherein step b) includes performing rule searches applied to said program graphs.

5. The method according to claim 1, wherein said software code subject to said static analysis techniques comprises one or more selected from the group comprising: object code, source code, a compiler intermediate representation, of said software code, and other program representations, or combinations thereof.

6. The method according to claim 3, wherein a program graph includes a control analysis graph, said static analysis technique automatically generating said control analysis graphs from said software code.

7. The method according to claim 3, wherein a program graph includes a data flow analysis graph, said static analysis technique automatically generating said data flow analysis graph from said software code.

8. The method according to claim 3, wherein a program graph includes an intraprocedural control graph, said static analysis technique automatically generating said intraprocedural control graphs from said software code.

9. The method according to claim 3, wherein a program graph includes an interprocedural control graphs, said static analysis technique includes automatically generating said interprocedural control graphs from said software code.

10. The method according to claim 5 wherein said static code analysis further includes automatically identifying classes, fields, methods and class attributes, said set of rules being further applied to said classes and class attributes.

11. The method according to claim 5 wherein said static code analysis further includes automatically identifying attributes of classes, methods, fields, and aspects of a program's body.

12. The method according to claim 5, wherein said step b) further includes the step of: receiving said program graphs and class attributes information and performing a graph rewriting technique.

13. The method according to claim 12, wherein a result of applying graph rewriting includes generating a run-time characteristics model for said program.

14. The method according to claim 12, wherein said step b) further includes the step of receiving said program graphs and attributes information, and performing a reachability analysis.

15. The method according to claim 14, wherein said reachability analysis is performed with or without constraints.

16. The method according to claim 14, further comprising the step of employing a rule search engine to automatically apply a set of rules to said rewrite graph results, reachability analysis results and attributes to identify one or more selected from the group of: possible performance errors or problems concerning correctness, security, privacy and maintainability of said software code.

17. The method according to claim 14, wherein said rewrite graph technique includes traversing a program graph to locate nodes containing attributes of interest and to locate edges to add or remove from said program graph.

18. The method according to claim 17, wherein said reachability analysis includes traversing the program graphs and adding or removing edges to extend or reduce reachability, respectively.

19. The method according to claim 18, wherein a rule is applied to determine whether a node representing a particular method is reachable by traversing said graph from a particular head node, said head node being user selectable.

20. A static analysis framework for analyzing software code, said framework comprising:
means for automatically generating program graphs;
rule search engine for automatically applying a set of rules to said program graphs;
means for automatically identifying potential software problems from rules set analysis results; and,
means for reporting said problems to enable correction of instances where one or more of best practices violations and common coding errors may occur.

21. The static analysis framework as claimed in claim 20, wherein said rules set represents one or more selected from the group comprising: use of best practices and common coding errors, or combinations thereof.

22. The static analysis framework as claimed in claim 20, wherein said software code comprises scalable componentized applications according to a software development platform.

23. The static analysis framework as claimed in claim 18, wherein said program graphs include one or more selected from the group comprising: a control analysis graph, a data flow analysis graph, an intraprocedural control flow graph and an interprocedural control flow graph, said static analysis technique automatically generating a respective one of said control analysis graph, data flow analysis graph, intraprocedural control flow graph and interprocedural control flow graph from said software code.

24. The static analysis framework as claimed in claim 23, further including means for automatically identifying classes, fields, methods and class attributes, said set of rules being further applied to said classes and class attributes.

25. The static analysis framework as claimed in claim 23, wherein said static code analysis further includes automatically identifying attributes of classes, methods, fields, and aspects of a program's body.

26. The static analysis framework as claimed in claim 20, wherein said means for automatically generating program graphs includes means for performing graph rewriting.

27. The static analysis framework as claimed in claim 26, wherein results of said graph rewriting include a run-time characteristics model for said program.

28. The static analysis framework as claimed in claim 26, wherein said means for automatically generating program graphs includes: means for performing a reachability analysis, said reachability analysis being performed with or without constraints.

29. The static analysis framework as claimed in claim 28, wherein said rule search engine automatically applies a set of rules to said rewrite graph results, reachability analysis results and attributes to identify one or more of: possible performance errors or problems concerning correctness, security and privacy of said software code.

30. A computer program device readable by a machine, tangibly embodying a program of instructions executable by a machine to perform method steps for analyzing software code, said method steps comprising:
a) automatically generating program graphs representing said code utilizing static analysis techniques;
b) automatically applying a set of rules to said program graphs;
c) automatically identifying potential software problems from rules set analysis results; and,
d) reporting said software problems to enable correction of instances where one or more of best practices violations and common coding errors may occur.
